(19) United States
(12) Patent Application Publication
(10) Pub. No.: US 2024/0254290 A1
(43) Pub. Date: Aug. 1, 2024

(54) POLYMERS OBTAINED FROM UNSATURED COMPOUNDS AND SULFURHALIDES

(71) Applicant: ARIZONA BOARD OF REGENTS ON BEHALF OF THE UNIVERSITY OF ARIZONA, Tuscon, AZ (US)

(72) Inventors: Dong Chul Pyun, Tucson, AZ (US); Robert Norwood, Tucson, AZ (US); Jon Njardarson, Tucson, AZ (US); Kyung-Seok Kang, Tucson, AZ (US); Richard GLASS, Tucson, AZ (US); Taeheon Lee, Tucson, AZ (US); Chisom OLIKAGU, Tucson, AZ (US); Kyle CAROTHERS, Tucson, AZ (US)

(73) Assignee: ARIZONA BOARD OF REGENTS ON BEHALF OF THE UNIVERSITY OF ARIZONA, Tuscon, AZ (US)

(21) Appl. No.: 18/598,881

(22) Filed: Mar. 7, 2024

Related U.S. Application Data
(63) Continuation of application No. PCT/US2022/043365, filed on Sep. 13, 2022.
(60) Provisional application No. 63/244,128, filed on Sep. 14, 2021.
(60) Provisional application No. 63/348,778, filed on Jun. 3, 2022.

(51) Int. Cl. C08G 77/60

(52) U.S. Cl. CPC C08G 77/60

(57) ABSTRACT

A polymer includes the reaction product of a mixture of a chalcogenide halide and one or more organic compounds comprising an unsaturated carbon-carbon bond under reaction conditions sufficient to produce the polymer, wherein the chalcogenide halide comprises a sulfur monohalide, a sulfur dihalide, a selenium monohalide, a selenium dihalide, a selenium tetrahalide, or a combination of any two or more thereof. Such sulfur-containing polymers have a high refractive index and high Abbe number and are suitable for use in variety of applications relating to optical devices.

### CROSS-REFERENCE TO RELATED APPLICATIONS

This application is a continuation of PCT/US2022/043365, filed on Sep. 13, 2022, and which claims the benefit of priority to U.S. Provisional Application No. 63/348,778, filed Jun. 3, 2022 and to U.S. Provisional Application No. 63/244,128, filed Sep. 14, 2021, all of which are hereby incorporated by reference in their entireties.

### FIELD

The present invention relates to a method for producing sulfur-containing polymers having a high refractive index and high Abbe number and are suitable for use in variety of applications relating to optical devices. In particular, the present invention provides a method for producing sulfur containing polymers using a chalcogen halide and one or more organic compounds comprising an unsaturated carbon-carbon bond.

### BACKGROUND

The consumer eyewear global market as of 2018 was estimated to be around $120 billion with products spanning spectacles, plano sunglasses, metal based eye-wear and contact lenses across numerous distributions channels). For this application, high volume, low cost optical polymers are required with outstanding optical properties with respect to color, transparency and refractive index, along with excellent thermomechanical properties and environmental stability. These materials afford large advantages over metal oxide glasses in areas such as weight reduction and fracture resistance.^{34,35} A number of optical figures of merit must be achieved for a polymer to be useful for specific optical application. For any plastic lens, the optical materials properties of interest are the summation of the refractive index (n), the chromatic dispersion as indicated by the “Abbe number (V_{D})”, and the optical transmittance (% T) in the visible spectrum. The refractive index (RI, or n) of a material determines the “focusing power” of fabricated lenses in a certain spectral window, at a wavelength of interest, where higher RI materials enable thinner, lighter lenses to be designed while maintaining suitable focal lengths for use as consumer spectacles and robust mechanical properties.³⁶ Hence, the plastic optics industry has spent decades to raise the RI of polymeric materials by inclusion of a high content of polarizable atoms, such as, sulfur, or bromine to raise the molar refraction.³⁷ The plastic eye-ware industry has recently pushed for lens materials with RI values exceeding n=1.65 in the visible spectrum. In addition to high refractive index, plastic lenses for consumer eye-ware must also have a sufficiently high Abbe number, which indicates the wavelength dependence of refractive index, or chromatic dispersion of an optical material. A high Abbe number indicates that refractive index values of lenses are fairly constant over the visible spectrum meaning that chromatic dispersion, the tendency of a lens to focus different colors at different positions, will be minimized.

Current optical polymer technology revolves principally around well-established thermoplastic, or thermoset polymers, such as, poly(methyl methacrylate)(PMMA), polyallylcarbonates (commercially, CR-39 from PPG), polycarbonates, poly(cyclic olefins)(e.g, TOPAS) and more recently from thermosetting resins based on episulfides & poly(thio)urethanes from companies such as Mitsui Chemical & Hoya.³⁶⁻⁴¹ PMMA and CR-39 are very high Abbe number polymers (V_{D}˜59) that have low RI (n˜1.5). Highly aromatic plastics, such as polystyrene, polycarbonates and polyimides, possess higher refractive indices (n=1.55-1.75), but have significantly lower Abbe numbers, where values below V_{D}<30 render these unusable for consumer eye-ware. In the vast majority of cases, high RI polymers above n=1.60 typically possess lower Abbe numbers and may be strongly colored, which has prompted significant investigation into new polymeric materials designed to balance both higher RI and Abbe number values.

The preparation of both high RI (n>1.60) and high Abbe number (V_{D}>30) plastic optics has primarily been achieved by the inclusion of a higher content of polarizable atoms and groups of high molar refraction, into either the backbone, or side chain groups of polymeric materials.³⁷ The primary focus of these improvements has been the preparation of sulfur containing polymers, since regulations and toxicity concerns preclude the introduction of selenium, or transition metal units. Notable discoveries include the synthesis and polymerization of 2,5-bis(sulfanylmethyl)-1,4-dithiane (BMMD) as initially reported and Okubo et al.⁴² Ueda et al. further explored BMMD chemistry via thiol-ene polymerizations, methacrylate free radical copolymerizations, or addition step-growth with diisocyanates to prepare high RI (n˜1.65) and high Abbe number (V_{D} ˜40) polymers.^{37,40,43,44} Stiegman et al. reported on the copolymerization standard dithiols, or bis-thiophenolic monomers with either multi-vinylic Group IV monomers (i.e., organo Si, Ge, Sn), or trivinyl phosphine chalcogenide (S,Se) monomers to form high RI copolymer networks with Abbe number ranging from V_{D}=20-33.^{45,46} Examples of industrially commercialized high RI//high Abbe number thermosets include Hoya's EYAS 160 polythiourethanes (n=1.60, V_{D}=40) made from the BMMD dithiol, tetrathiols and diisocyanates, along with Hoya's EYVIA 174 (n=1.74, V_{D}=30) made from bis-episulfides, dithiols and elemental sulfur.^{39,47}

Despite these advances, the major issue with larger scale production of high RI and high Abbe number consumer plastic lenses has been the high cost associated with di-, multi-thiol monomers. While thiol compounds are certainly commercially available, there remain a limited choice of di-, multi-thiol compounds available, which requires the optics industry to conduct multi-step synthesis of specialty dithiane dithiol monomers, such as, BMMD, which ultimately results in small scale, low volume production of high RI plastic lenses. Hence, there remains a technological need for new polymerization chemistry to incorporate a high content of sulfur atoms using inexpensive sulfur containing monomers that are suitable for high volume optical plastics.

This disclosure addresses this need by providing sulfur containing polymers prepared from chalcogen halides, such as sulfenyl chloride, and one or more organic compounds comprising an unsaturated carbon-carbon bond (e.g., allylic monomers comprising arenes, cycloalkanes, and combinations of these motifs and aliphatic allylics) that have a high refractive index (RI) and high Abbe number. Such polymers are suitable in a variety of application relating to optical devices.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### SUMMARY

Some aspects of the invention relate to processes for producing organochalcogenide polymers without using molten sulfur. In particular, some aspects of the invention provide processes for producing organochalcogen polymers at a relatively lower temperature compared to conventional methods that involve use of molten sulfur, which require high temperatures, e.g., 120° C. to 180° C. or higher.

Another limitation of conventional methods is that elemental sulfur or molten sulfur has limited miscibility with organic comonomers. In contrast, methods of the invention use chalcogenide sources that are miscible with organic comonomers.

The polymers and compositions described herein address the need for the development of new polymer chemistry that can provide for the large scale production of high RI and high Abbe number optical polymers that can replace current methods that use di-, multi-thiol monomers, which are costly. The methods described here incorporate a high content of sulfur atoms using inexpensive sulfur containing monomers, such as sulfenyl chlorides, that have largely ignored by the chemical industry due to concerns relating to the hydrolytic stability of such compounds. However, this disclosure shows that such sulfur containing monomers can be used to prepare polymers for high volume optical plastics and have a high RI and high Abbe number.

Provided in one aspect is a composition comprising a polymer (e.g., a sulfur containing polymer) that is a reaction product of a mixture of a chalcogenide halide and one or more organic compounds comprising an unsaturated carbon-carbon bond under reaction conditions sufficient to produce the polymer, wherein the chalcogenide halide comprises a sulfur monohalide, a sulfur dihalide, a selenium monohalide, a selenium dihalide, a selenium tetrahalide, or a combination of any two or more thereof.

In some embodiments, the chalcogenide halide is selected from the group consisting of sulfur monochloride, sulfur monobromide, selenium monochloride, selenium monobromide, selenium dichloride, selenium dibromide, selenium tetrachloride, selenium tetrabromide, and a combination of any two or more thereof. In some embodiments, the chalcogenide halide is sulfur monochloride.

In some embodiments, the unsaturated carbon-carbon bond comprises a carbon-carbon double bond, a carbon-carbon triple bond, or a combination of any two or more thereof. In some embodiments, the organic compound comprises at least two unsaturated carbon-carbon bonds. In some embodiments, the organic compound comprises at least three unsaturated carbon-carbon bonds.

In some embodiments, the organic compound comprises a vinyl olefin, an allyl olefin, a styrenic olefin, an α-methylstyrenic olefin, a (meth)acrylate olefin, a norbornene, a cyclic olefin, a vinylogous sulfide, a substituted alkene olefin, a maleimide, a maleic anhydride, or a combination of any two or more thereof.

In some embodiments, the organic compound comprises a terephthalate, an isophthalate, a bisphenol A or derivative thereof, 4,4-methylene diphenyl (MDI), a trifunctional terephthalate, a tris-phenolic core, a isocyanurate, a phosphazene, a siloxane, a isocorbide, a naturally occurring product, or a combination of any two or more thereof. In some embodiments, the organic compound comprises a terephthalate, an isophthalate, a bisphenol A or derivative thereof, 4,4-methylene diphenyl (MDI), a trifunctional terephthalate, a tris-phenolic core, a isocyanurate, or a combination of any two or more thereof. In some embodiments, the organic compound comprises 1,3-diallyl isophthalate (DAI), diallyl tetrabromo-bisphenol A (DABr₄BPA), triallyl isocyanurate (TIC), or a combination of any two or more thereof.

In some embodiments, the polymer is produced by a process comprising admixing a monomeric mixture comprising the chalcogenide halide and the one or more organic compound comprising an unsaturated carbon-carbon bond under suitable reaction conditions. In some embodiments, the monomeric mixture is admixed in the presence of an organic solvent.

In some embodiments, the organic solvent comprises a polar organic solvent, a non-polar aprotic organic solvent, or a combination of any two or more thereof. In some embodiments, the organic solvent comprises tetrahydrofuran, toluene, benzene, xylene, chlorobenzene, dichlorobenzene, diethyl glycol, N,Ndimethylformamide, carbon disulfide, halogenated solvents such as dichloromethane, chloroform, or a combination of any two or more thereof.

In some embodiments, the process is conducted at a reaction temperature of about 200° C. or less or about 100° C. or less. In some embodiments, the process is conducted at a reaction temperature of from about 50° C. to about 100° C. In some embodiments, the process is conducted at a reaction temperature of from about 65° C. to about 75° C.

In some embodiments, the monomeric mixture further comprises one or more elemental sulfur derived copolymers, such as a poly(sulfur-random-styrene).

In some embodiments, the polymer has a refractive index of about 1.6 or higher in the visible spectrum, or near and/or short wave infrared spectral windows. In some embodiments, the polymer has a refractive index of from about 1.5 to about 1.75 in the visible spectrum, or near and/or short wave infrared spectral windows.

In some embodiments, the polymer has an Abbe number of about 20 or higher. In some embodiments, the polymer has an Abbe number of about 30 or higher.

In some embodiments, the polymer has a number averaged molecular weight (Mn) of about 50,000 or greater, about 80,000 or greater, or about 100,000 or greater. In some embodiments, the polymer has an optical transmittance of about 90% or greater in the visible, NIR, or SWIR spectrum, or at specific wavelengths of interest in these spectral windows. The polymers described herein may be used to prepare crosslinked polymer networks or thermosets.

In some embodiments, the compositions described herein are thermoplastic materials that are soluble and melt processable. In some embodiments, the compositions described herein are thermoset materials with high transparency in the visible spectrum and are amorphous and glassy.

Provided in one aspect is a process for producing any one of the compositions described herein, comprising admixing a monomeric mixture comprising a chalcogenide halide and an organic compound comprising an unsaturated carbon-carbon bond under reaction conditions sufficient to produce a polymer, wherein said chalcogenide halide comprises a sulfur monohalide, a sulfur dihalide, a selenium monohalide, a selenium dihalide, a selenium tetrahalide, or a combination of any two or more thereof.

In some embodiments, the monomeric mixture comprises olefinic comonomers, the polymer is a segmented or statistical copolymer. In some embodiments, the monomeric mixture comprises olefinic comonomers, the composition is used to prepare a elastomer or a ductile plastic. In some embodiments, the monomeric mixture comprises a solvent. In some embodiments, the monomeric mixture does not comprise a solvent (e.g., bulk polymerization).

In some embodiments, the process further comprises purifying the polymer. In some embodiments, purifying the polymer comprises the steps of: (a) dissolving the polymer in an organic solvent to produce a homogeneous solution; (b) precipitating said the polymer to produce at least a partially purified the polymer; and (c) optionally repeating steps (a) and (b).

In some embodiments, the polymer has a purity of at least about 90%, including about 90%, about 91%, about 92%, about 93%, about 94%, about 95%, about 96%, about 97%, about 98%, and about 99%. In some embodiments, the process is used to prepare soluble linear, branched, or insoluble network thermosets. In some embodiments, the process is performed in bulk to mold or cast optical components (such as windows or lenses).

One particular aspect of the invention provides a method for producing organochalcogen polymers using a chalcogen halide. One of the differences of methods of the invention relative to conventional methods is the lower total incorporation of chalcogenide moieties (e.g., disulfide S—S vs longer chains SS bonds), which may affect other bulk properties such as, lowered refractive index and reduced IR transparency.

### BRIEF DESCRIPTION OF THE DRAWINGS

FIG. 1 shows the optical transmission spectrum of the poly(S₂-DAI-Cl₂) (also known as poly(S-IP-Cl)) polymer film (0.1 mm). This polymer film exhibited greater than 80% T in the visible spectrum and a refractive index of 1.60, according to the examples. DAI=diallyl isophthalate.

FIG. 2 shows the refractive index and transmittance (%) of the poly(S₂-DAI-Cl₂) (also known as poly(S-IP-Cl)) polymer film that was coated on a Si wafer, according to the examples.

FIG. 3 shows the SEC chromatograms of the poly(disulfide-tri-isophthalate-dichloride) polymers before and after purification, according to the examples.

FIG. 4 shows the DSC curve of the poly(disulfide-tri-isophthalate-dichloride) polymer from −50° C. to 150° C. with a heating rate of 10° C./min, according to the examples.

FIG. 5 shows the ellipsometric characterization of the refractive index vs wavelength for the above described poly(S₂-DAI-Cl₂) polymer, according to the examples.

FIG. 6 shows SEC chromatogram the of poly(S₂-DAI-Cl₂) polymer in THF mobile phase, according to the examples.

FIGS. 7A and 7B show the TGA and DSC thermograms of poly(S₂-DAI-Cl₂) polymer, according to the examples.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be constructed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

As used herein, the terms “those defined above” and “those defined herein” when referring to a variable incorporates by reference the broad definition of the variable as well as any narrow and/or preferred definitions, if any.

This disclosure recognizes that polymer and compositions described herein have advantageous optical properties that make these polymer/compositions useful in a variety of applications, including consumer plastic optical spectacle lenses, optical polymer thermoset windows, optical lenses, thicker optical windows, and optical elements. These properties include having high RI (e.g., RI>1.6-1.70 with RI of ˜1.65 as preferred) with a high Abbe number (e.g., >20 with >30 preferred) and low or limited coloration, which allows for yellow or red for optical applications at longer wavelengths in the near an shortwave IR. Also the polymer and compositions described herein can provide thermoplastics with high Tg (e.g., Tg>50° C.) and thermosets prepared from S₂Cl₂ and triallyl monomers that are inexpensive, highly transparent, have high RI (n=1.6) as compared to PMMA-plexiglass. The polymer and compositions described herein provide thermoplastics and thermosets having high melting transitions Tm greater than 100° C.

It is the inventors of the present disclosure that recognized that the polymers prepared from S₂Cl₂ and one or more of the organic compounds described herein may be used to make quality thermoplastics and thermosets. This is significant as S₂Cl₂ has been largely ignored by chemical industry due to concerns of hydrolytic stability of sulfenyl chlorides. However, when compared to liquid molten elemental sulfur which is tough media to work in, S₂Cl₂ is a soluble, stable liquid monomer media that can be used to high molecular weight plastics that have high Tg and are highly transparent.

Three elements of Group 16 in the periodic table, namely, sulfur, selenium, and tellurium, are called sulfur group elements or chalcogens. Chalcogen containing polymers (also called organochalcogenide polymers) have unique physical and optical properties. In particular, organochalcogen polymers exhibit glass-like physical properties and are used in many optical and sensor applications. Uses include visible and/or infrared detectors, moldable visible and/or infrared optics such as lenses, gratings, diffractive optical elements, beam splitters, and visible and/or infrared optical fibers, with the main advantage being that these materials transmit across a wide range of the visible and/or infrared electromagnetic spectrum.

The physical properties of chalcogen polymers (e.g., chalcogen glasses) include, but are not limited to, high refractive index, low phonon energy, high nonlinearity, as well as other properties. Such properties make them ideal for incorporation into lasers, planar optics, photonic integrated circuits, and other electronic devices and sensors.

Conventional methods for producing sulfur organochalcogen polymers involve combining molten sulfur with organic comonomers to form stable organochalcogen polymers. One of the advantages of organochalcogen polymers is that they can possess important optical properties, such as high refractive index and strong infrared (IR) transmission, while being easier to fabricate than glass materials with similar optical properties. Some organohalcogen polymers can also be used for solid membranes of various types of solid-state chemical sensors and fiber optics. Based on these various properties, organochalcogen polymers, such as sulfur-containing polymers and selenium-containing polymers are regarded as excellent functional polymer materials in a wide variety of electronic devices.

Unfortunately, however, use of molten sulfur requires a high reaction temperature for producing organochalcogen polymers. In addition, use of a high reaction temperature limits the type of organochalcogen polymers produced and/or reduces the yield of organochalcogen polymer. Furthermore, polymers made from elemental sulfur are often strongly colored which severely limits use for optical applications in the visible spectrum.

Described herein are methods of producing organochalcogen polymers without using molten sulfur or a reaction temperature that is typical of conventional organochalcogen polymer synthesis. In particular, methods of the invention utilize a chalcogen halide to produce organochalcogen polymers under a significantly lower reaction temperature. Furthermore, unlike elemental sulfur the reagents used in methods of the invention are miscible in organic solvents, thereby allowing ease of processing in both reaction and purification step compared to conventional methods using molten sulfur.

It should be appreciated that while the present invention is described with regard to producing sulfur-organochalcogen polymers, which assist in illustrating various features of the invention, the scope of the invention is not limited to sulfur-containing organochalcogen polymers but includes organochalcogen polymers containing sulfur, selenium, tellurium, and a combination of two or more thereof. In this regard, the present invention generally relates to producing organochalcogen polymers such as organochalcogen polymers containing sulfur, selenium, tellurium, or a mixture thereof. In particular, methods for producing sulfur-containing organochalcogen polymers are disclosed herein.

Provided in another aspect is a composition comprising a polymer (e.g., organochalcogen polymer) that is a reaction product of a mixture of a chalcogenide halide or a and one or more organic compounds comprising an unsaturated carbon-carbon bond under reaction conditions sufficient to produce the polymer, wherein the chalcogenide halide comprises a sulfur monohalide, a sulfur dihalide, a selenium monohalide, a selenium dihalide, a selenium tetrahalide, or a combination of any two or more thereof.

Accordingly, while the remainder of the present disclosure is directed to a method for producing various sulfur-containing organochalcogen polymers, one skilled in the art having read the present disclosure can readily recognize that the scope of the invention is not limited to sulfur-containing organochalcogen polymers but includes other organochalcogen polymers such as those containing, sulfur, selenium, tellurium, and a mixture thereof. Synthesis of other organochalcogen polymers can be readily achieved, for example, by replacing a sulfur halide with a selenium halide, tellurium halide, or a mixture there.

Accordingly, the following discussion for methods for producing sulfur containing organochalcogen polymers is provided solely for the purpose of illustrating the practice of the invention and does not constitute limitations on the scope of the present invention.

Some aspects of the invention provide methods and processes for producing organochalcogen polymers using a chalcogen halide, such as, but not limited to, sulfur halide (e.g., sulfur mono- or di-halide), selenium halide (e.g., selenium mono-, di-, or tetrahalide), tellurium halide, or a combination thereof.

Methods and processes of the invention include using sulfenyl chloride molecular compounds, functional polymers and chalcogenide halide monomers for the synthesis of new polymeric materials. In one particular example, sulfur monochloride (S₂Cl₂) is copolymerized with unsaturated organic monomers. As used herein, the term “unsaturated organic monomer” refers to an organic compound having one or more carbon-carbon double or carbon-carbon triple bonds. In some embodiments, the organic compound comprises at least two unsaturated carbon-carbon bonds. In some embodiments, the organic compound comprises at least three unsaturated carbon-carbon bonds. Exemplary organic comonomers include ethylenically unsaturated monomers, vinylic monomers, cyclic olefins (such as norbornenes, other bicyclic olefins), alkynes, styrenics, methacrylate, allylics, norbornenes, cyclic olefins, substitutes alkenes, vinylogous sulfides, alkynes, maleimides, maleic anhydride, as well as polymers and oligomers carrying these polymerizable groups.

Other suitable organic monomers include organic compounds with classical step-growth polymerization core monomers based on, for example, terephthalates, isophthalates, bisphenol A and BPA derivatives, 4,4-methylene diphenyl (MDI), trifunctional terephthalates, tris-phenolic cores, isocyanurates, phosphazenes, siloxanes, isocorbides, naturally occurring products. In some embodiments, the organic compound comprises a terephthalate, an isophthalate, a bisphenol A or derivative thereof, 4,4-methylene diphenyl (MDI), a trifunctional terephthalate, a tris-phenolic core, a isocyanurate, a phosphazene, a siloxane, a isocorbide, a naturally occurring product, or a combination of any two or more thereof. In some embodiments, the organic compound comprises a terephthalate, an isophthalate, a bisphenol A or derivative thereof, 4,4-methylene diphenyl (MDI), a trifunctional terephthalate, a tris-phenolic core, an isocyanurate, or a combination of any two or more thereof. In some embodiments, the organic compound comprises 1,3-diallyl isophthalate (DAI), diallyl tetrabromo-bisphenol A (DABr₄BPA), triallyl isocyanurate (TIC), or a combination of any two or more thereof. Other contemplated organic compounds include but are not limited to cycloalkane diacid/diesters, including cyclohexane diacids/diesters, napthalate diester monomers, aromatic and cycloalkane carbamate monomers with diallyl groups, triazines and isocyanurate triallyl monomers. In some embodiments, the organic compound comprises a cycloalkane diacid/diester, including cyclohexane diacid/diester, napthalate diester monomer, aromatic and cycloalkane carbamate monomer with an diallyl group, triazine and isocyanurate triallyl monomer. In general, the scope of the invention includes any and all organic monomer that include one or more carbon-carbon unsaturated bonds that can react with the chalcogen halide. In some embodiments, the carbon-carbon unsaturated bond comprises a carbon-carbon double bond, a carbon-carbon triple bond, or a combination of any two or more thereof.

The addition of sulfur-chlorine, sulfur-bromine and/or selenium chloride, selenium bromine, tellurium chloride, tellurium bromide groups result in what are generally referred to as “chalcogenide halides”, which are organic solvent soluble chemicals that are extremely reactive toward alkenes and other unsaturated monomers. Without being bound by any theory, it is believed that this strong reactivity creates a driving force for polymerization while also allowing these reactions to be done in organic solvent solutions at lower temperature (e.g., reaction temperature of as low as −78° C.) to room temperature, or above. This is in stark contrast to the inverse vulcanization process using liquid or molten sulfur, which must be done at high temperatures in neat, liquid or molten sulfur media, which has very limited solubility/miscibility with most conventional organic comonomers.

Methods and processes of the invention generally can be referred to as a direct copolymerization of S₂Cl₂ with olefins and alkynes, which is referred to herein as “Chalcogenide Halide Inverse Vulcanization” or “Sulfenyl Chloride Inverse Vulcanization.” In some embodiments, methods of the invention allow polymerization of disulfide (i.e., two S—S bonds) or diselenide per monomer unit. In some embodiments, organochalcogen polymers produced using methods of the invention have a lower sulfur (selenium or tellurium) content than the inverse vulcanization using, for example molten or liquefied sulfur. However, the higher reactivity and a significantly higher solubility of chalcogen halide (e.g., S₂Cl₂) compared to liquid sulfur enables ease of processing (e.g., isolation and/or purification) of the organochalcogen polymers that are produced using methods of the invention.

Methods of the invention include admixing a monomeric mixture comprising: (i) a chalcogenide halide and (ii) one or more organic compounds comprising an unsaturated carbon-carbon bond under reaction conditions sufficient to produce said organochalcogenide polymer. The chalcogenide halide is selected from the group consisting of sulfur monohalide, sulfur dihalide, selenium monohalide, selenium dihalide, selenium tetrahalide, and a combination thereof.

In some embodiments, said chalcogenide halide is selected from the group consisting of sulfur monochloride, sulfur dichloride, sulfur monobromide, selenium monochloride, selenium monobromide, selenium dichloride, selenium dibromide, selenium tetrachloride, selenium tetrabromide and a combination thereof. Still in other embodiments, said chalcogenide halide is selected from the group consisting of sulfur monochloride, sulfur dichloride, selenium monochloride, selenium dichloride, selenium tetrachloride, and a combination thereof.

In some embodiments, said monomeric mixture is admixed in the presence of an organic solvent. In some instances, said organic solvent comprises a polar organic solvent, a non-polar aprotic organic solvent, or a combination thereof. Exemplary organic solvents that are useful in methods of the invention include, but are not limited to, tetrahydrofuran, toluene, benzene, xylene, chlorobenzene, dichlorobenzene, diethyl glycol, N,N-dimethylformamide, carbon disulfide, halogenated solvents such as dichloromethane, chloroform and a combination thereof.

In further embodiments, said unsaturated carbon-carbon bond comprises a carbon-carbon double bond, a carbon-carbon triple bond, or a combination thereof.

In some embodiments, the polymer (e.g., the organochalcogenide polymer) is produced at a reaction temperature of about 200° C. or less, typically about 150° C. or less, often 100° C. or less, more often about 90° C. or less, and most often about 80° C. or less. In some embodiments, the process is conducted at a reaction temperature of about 200° C. or less or about 100° C. or less. In some embodiments, the process is conducted at a reaction temperature of from about 50° C. to about 100° C. In some embodiments, the process is conducted at a reaction temperature of from about 65° C. to about 75° C. In some embodiments, the process is conducted at a reaction temperature of from about 0° C. to about 50° C.

In further embodiments, an amount of said chalcogenide halide used is about 90 mole % or less, typically about 80 mole % or less, and often about 75 mole % or less relative to an amount of said organic compound.

Still in further embodiments, the refractive index of organochalcogen polymers produced using methods of the invention have a lower refractive index (“RI”) in the visible spectrum compared to those produced using liquid or molten sulfur inverse vulcanization. In some embodiments, the RI of organochalcogen polymers produced using methods of the invention ranges from about 1.3 to about 1.9, typically from about 1.4 to about 1.8, often from about 1.5 to about 1.75, and most often from about 1.55 to about 1.7 in the visible spectrum. As used herein, the RI values are for those in visible spectrum, namely, in wavelength range from about 380 to about 750 nanometers. In some embodiments, the refractive index and Abbe numbers, see infra, refer to refractive indices at the wavelengths of the Fraunhofer C, D1, and F spectral lines (656.3 nm, 589.3 nm, and 486.1 nm respectively).

Other aspects of the invention provide an organochalcogenide polymer produced from a process comprising admixing a monomeric mixture comprising: (i) a chalcogenide halide and (ii) one or more organic compounds comprising an unsaturated carbon-carbon bond under reaction conditions sufficient to produce said organochalcogenide polymer, wherein said chalcogenide halide is selected from the group consisting of sulfur monohalide, selenium monohalide, selenium dihalide, selenium tetrahalide, and a combination thereof.

In some embodiments, the polymer is produced by a process comprising admixing a monomeric mixture comprising the chalcogenide halide and the one or more organic compound comprising an unsaturated carbon-carbon bond under suitable reaction conditions. In some embodiments, the monomeric mixture is admixed in the presence of an organic solvent.

The polymers produced using methods of the invention (e.g., organochalcogen polymers) are significantly less colored and have higher Abbe number (an optical metric for the wavelength dependence of the refractive index; higher Abbe number indicates low wavelength dependence of the refractive index and generally high transparency). In some embodiments, Abbe number of the polymers produced using methods of the invention (e.g., organochalcogenide polymers) is about 20 or higher, typically about 30 or higher, often 40 or higher, and most often about 50 or higher. In some embodiments, the polymer has an Abbe number of about 20 or higher. In some embodiments, the polymer has an Abbe number of about 30 or higher.

Also, in some embodiments, the polymer described herein are used to prepare S₂Cl₂ thermosets having very low birefringence (delta n>0.01) in the visible and near infrared spectrum, which is 10× lower than commodity optical polymer-polycarbonate) and allows for the molding of very thick, highly transparent optical components. In contrast, polycarbonates cannot be molded into thick optics due to birefringence derived haziness (delta n˜0.01 at 633 nm).

The polymers produced using methods of the invention (e.g., organochalcogen polymers) typically have RI of about 1.6 with high Abbe number. In some embodiments, the polymer has a refractive index of about 1.6 or higher in the visible spectrum, or near and/or short wave infrared spectral windows. In some embodiments, the polymer has a refractive index of from about 1.5 to about 1.75 in the visible spectrum, or near and/or short wave infrared spectral windows. As such, the polymers of the invention (e.g., organochalcogen polymers) can be used in a wide variety of applications including, but not limited to, plastic optical components, which include free standing lenses, Fresnel lenses, windows, and support micro-optics such as microlens arrays and diffractive optical elements, and as high RI elastomeric materials for use in stretchable fiber optics and flexible displays. Specific examples of utility of the polymers of the invention (e.g., organochalcogen polymers) include, but are not limited to, plastic optics for consumer spectacles and Smartphone plastic optics. Other uses of the polymer of the invention (e.g. organochacogenide polymers) include, but are not limited to, applications in electronic devices and optical-electrical devices, such as, for example, optical detection devices, electronic detection devices, automobiles, infrared detection devices, photonics, optical information storage devices, etc.

The polymers described herein have high molecular weights. In some embodiments, the polymer has a number averaged molecular weight (Mn) of about 5,000 or greater, about 10,000 or greater, about 50,000 or greater, about 80,000 or greater, about 100,000 or greater, about 200,000 or greater, about 300,000 or greater, about 400,000 or greater, about 500,000 or greater, and about 600,000 or greater, including about 5,000, about 10,000, about 50,000, about 60,000, about 70,000, about 80,000, about 90,000, about 100,000, about 110,000, about 120,000, about 150,000, about 200,000, about 300,000, about 400,000, about 500,000 and 600,000. In some embodiments, polymer has a number averaged molecular weight (Mn) of from about 5,000 to about 20,000, from about 10,000 to about 40,000, or from about 30,000 to about 50,000. In some embodiments, polymer has a number averaged molecular weight (Mn) of from about 130,000 to about 300,000 or about 200,000 to about 600,000.

The polymers described herein have an optical transmittance of from about 70% to about 99% in the visible, NIR, or SWIR spectrum, or at specific wavelengths of interest in these spectral windows, including about 70%, about 75%, about 80%, about 85%, about 90%, about 95%, and about 99%. The polymers described herein may have an optical transmittance of about 90% or greater in the visible, NIR, or SWIR spectrum, or at specific wavelengths of interest in these spectral windows, including about 90%, about 91%, about 92%, about 93%, about 94%, about 95%, about 96%, about 97%, about 98%, and about 99%.

Provided in one aspect is a process for producing any one of the compositions described wherein, comprising admixing a monomeric mixture comprising a chalcogenide halide and an organic compound comprising an unsaturated carbon-carbon bond under reaction conditions sufficient to produce a polymer, wherein said chalcogenide halide comprises a sulfur monohalide, a sulfur dihalide, a selenium monohalide, a selenium dihalide, a selenium tetrahalide, or a combination of any two or more thereof.

In some embodiments, the monomeric mixture further comprises one or more elemental sulfur derived copolymers, such as a poly(sulfur-random-styrene). Examples of such polymers include those described in WO2017011533, WO2013023216, and U.S. Pat. No. 9,567,439, which are incorporated by reference for the disclosure of such compounds.

In some embodiments, the process further comprises purifying the polymer. In some embodiments, purifying the polymer comprises the steps of:
(a) dissolving the polymer in an organic solvent to produce a homogeneous solution;
(b) precipitating said the polymer to produce at least a partially purified the polymer; and
(c) optionally repeating steps (a) and (b).

In some embodiments, methods of the invention provide polymers (e.g., organochalcogenide polymers) having a purity of at least about 80%, typically at least about 85%, often at least about 90%, and more often at least about 95%. In some embodiments, the polymer has a purity of at least about 90%, including about 90%, about 91%, about 92%, about 93%, about 94%, about 95%, about 96%, about 97%, about 98%, and about 99%.

Still in some embodiments, a yield of the polymers described herein (e.g., organochalcogenide polymers) is about 50% or higher, typically about 60% or higher, and often about 70% higher relative to the amount of said organic compound used.

Sulfenyl chlorides are a widely known but largely ignored class of sulfur compounds that are highly reactive toward nucleophiles and electrophilic unsaturated compounds. Sulfenyl chlorides are closely related to organosulfur thiol and mercaptan molecules where the R—S—H bond is replaced via chlorination reactions to form the R—S—Cl, which constitutes the sulfenyl chloride moiety. The S—Cl functional group is dipolar covalent in nature and can be considered a strong electrophile for attack by nucleophilic compounds such as, alcohols/alkoxides, Grignard reagents, organolithium reagents to form various organodisulfide compounds.

One particular illustrative example of methods of the invention is an electrophilic addition of (organo)sulfenyl chlorides to unsaturated compounds, which primarily comprise alkenyl and alkynyl molecules such as vinylics, styrenics, acrylates, allylics, cyclic olefins, and both internal and terminal alkynes. The electrophilic addition of organosulfenyl chlorides, such as, benzenesulfenyl chloride (Ph-S—Cl) to strained cyclic olefins, such as, norbornene has been extensively studied, where the mechanism is proposed to proceed via ionic processes through episulfonium intermediates, followed by addition of the chloride anion with anti-stereochemistry to form organosulfur halides. These reactions proceed spontaneously in solution, in the bulk (i.e., neat) and can be done at very low temperatures (T˜−78° C.). The electrophilic addition of sulfenyl chlorides to unsaturated compounds is a close cousin to “thiol-ene addition reaction” of thiols to unsaturated compounds, but has mechanistic differences and distinctive functional group tolerances which offer unique opportunities for application to the synthesis of advanced polymeric materials.

This class of organosulfur compounds is largely based on derivatives of organothiols and organodisulfides since sulfenyl chlorides are typically prepared by direct chlorination of these compounds (using sulfuryl chloride, or N-chlorosuccinimide). These routes largely have been reported to afford organosulfenyl chlorides with monofunctional R—S—Cl motifs where the R-group is typically aliphatic, or aromatic thiophenol type compounds. Wholly inorganic families of sulfenyl chlorides have been made and widely used, which include sulfur dichloride (SCl₂), sulfur monochloride (S₂Cl₂) which also adds with high efficiency/potency to unsaturated olefinic molecules. S₂Cl₂ in particular has a long history of use in crosslinking/vulcanization of natural rubber, styrene-butadiene rubber, butyl rubber, where addition of this sulfenyl chloride is so exothermic that very cold temperatures must be used to make the crosslinked rubber, which is referred to as “cold vulcanization.” There have been only a few publications on the use of sulfur monochloride as a comonomer for making polymers, which include copolymerizations with butadienes and cyclic olefins. Unfortunately, these earlier works did not provide any useful polymers but mainly afforded intractable polymers with limited utility. It appears these disappointing results may have played a large role in discouraging others from further pursuing usefulness of chalcogenide halides for producing polymers. However, undiscouraged by these earlier results, the present inventors sought to take advantage of a high reactivity of chalcogenide halides to produce commercially useful organochalcogen polymers. At least a part of the invention is based on the discovery of useful reaction conditions by the present inventors in utilizing chalcogenide halides to produce commercially useful organochalcogen polymers. Accordingly, methods and processes disclosed herein provide heretofore unattainable organochalcogen polymers that have various useful and/or desirable physical properties, e.g., minimum coloring, high refractive index, etc.

The addition of sulfenyl chlorides can be considered a “Click” type reaction that is a highly efficient thermodynamically driven addition reaction as observed for the alkynesazides, thiols-enes, and alcohols and isocyanates. S—Cl Click reactions can be similarly achieved by the functionalization of polymers with S—Cl groups and reacting with a 2nd disparate polymer that carries reactive unsaturated groups. The following describe some examples of these types of reactions.

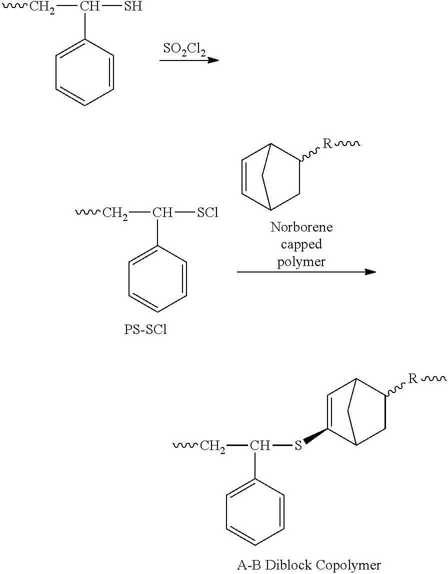

A polystyrene, or any polymer that carries a single thiol can be converted to a SCI end group by chlorination, e.g., with SO₂Cl₂, and reacted with a 2nd end-functional polymer that carries a vinyl end group, a cyclic olefin end group, an alkyne end group, or other carbon-carbon unsaturated bond, where the S—Cl addition to the olefinic, or alkynyl end group results in a block copolymer synthesis. Thiol end-functional polymers can be readily prepared using controlled radical polymerizations, such as, atom transfer radical polymerization (ATRP), or Reversible Addition Fragmentation Chain Transfer (RAFT) polymerizations, using either functionally protected initiators, or by end-group transformations. Disulfide initiators for ATRP and RAFT can also be used to form polymers that after chlorination reactions cleaves the S—S bonds to install S—Cl end groups. Conversely, norbornene or vinyl end groups can be installed by use of functional initiators or end group modifications using methods known to one skilled in the art.

The mono-functional S—Cl whether on small molecules, or polymers as reactive end-groups can readily add to the internal olefins of polydienes, such as, polybutadiene, polyisoprene and polynorbornenes. The example provided shows the reaction of benzene sulfenyl chloride (Ph-S—Cl) adding to polybutadiene, which installs both Ph-S and —Cl groups across the double bond. Since the S—Cl group attaches to a wide range of molecules and polymers, this route offers a new route to polydiene modification.

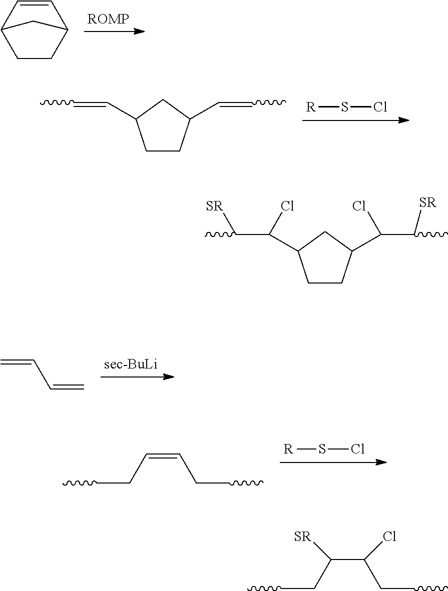

Difunctional sulfenyl chloride compounds can be used as comonomers with divinyl, di-olefinic, di-alkynyl comonomers to achieve A₂+B₂ step growth polymerization. Commercially available dithiols are typically thiophenolic compounds such as, 4,4-thiobisbenzenethiol, benzene-dithiols (both 1,3 an 1,4 isomers), or aliphatic dithiols (e.g., 1,2-decanedithiol), which can be readily chlorinated to make an A₂-type disulfenyl chloride monomer. Macromonomers can be prepared by chlorinating dithiol prepolymers and oligomers that include poly(ethylene glycol), poly(dimethylsiloxane)(PDMS). This polymerization is a high addition polymerization with any divinyl, multi-vinyl, multi-unsaturated compound which include norbornadiene, norbornene derivatives, styrenics, acrylates, vinylics either as small molecule comonomers, or macromonomers.

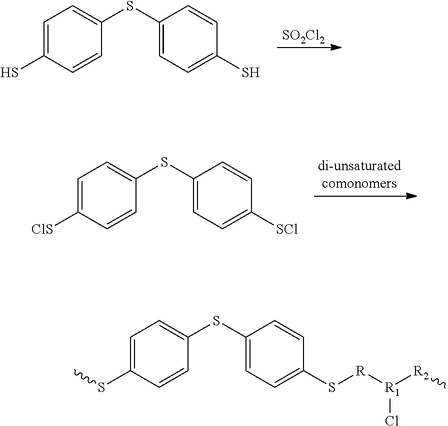

Exemplary di-unsaturated comonomers include, but are not limited to, the following alkenes and alkynes:

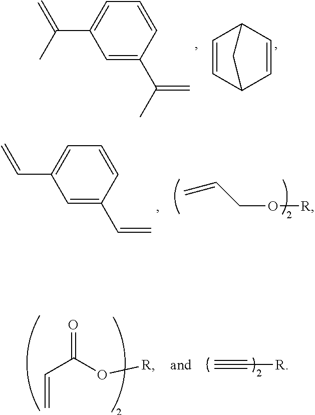

Sulfur monochloride (S₂Cl₂) is an inexpensive chemical that is industrially produced for various applications in the rubber industry. This compound is stable under ambient conditions and highly miscible with conventional organic solvents and organic comonomers such as vinylics, styrenics, acrylates, norbornenes, cyclic olefins, alkynes. Furthermore, the compound is wholly made of S—Cl groups which can serve as an A₂-type step growth monomer that can deliver a controlled polymerization of disulfide when paired with a di-, or multiunsaturated organic comonomer. The sulfur monochloride polymerization with activated olefins which include norbornadienes (NBD), norbornenes, cyclic olefins, vinylics, styrenics, acrylates are highly reactive, exothermic reactions and are typically conducted in solution and/or at low temperature (e.g., T=−78° C. to 0° C.). Allylic monomers are more stable when mixed with sulfur monochloride at room temperature and because of this chemical stability are useful monomers with sulfur monochloride to perform bulk polymerizations at elevated temperatures (T=50-100° C.).

Use of sulfur monochloride instead of liquid sulfur has numerous advantages since elemental sulfur/liquid sulfur requires high reaction temperatures (e.g., typically reaction temperature in the range of 120° C. to 180)° ° C. and has limited miscibility with organic comonomers. In contrast, sulfur monochloride is readily miscible with organic media, can react with a much wider range of organic comonomers over a wider range of conditions (e.g., in bulk, solution, high or low T). One of the properties of resulting organochalcogen polymers of the invention in using sulfur monochloride vs elemental sulfur is the lower total incorporation of sulfur/chalcogenide moieties (disulfide S—S vs longer chains SS bonds), which may affect bulk properties.

The present invention, thus generally described, will be understood more readily by reference to the following examples, which are provided by way of illustration and are not intended to be limiting of the present invention.

### Examples

The following examples more specifically illustrate protocols for preparing compounds and devices according to various embodiments described above. These examples should in no way be construed as limiting the scope of the present technology.

One of the plastics achieved using methods of the invention, e.g., by the S—Cl inverse vulcanization, has been the polymerization of S₂Cl₂ with diallylic comonomers, such as, 1,3-diallyl isophthalate; 1,4-diallyl terephthalate; and diallyl bisphenol A based comonomers. These polymerizations proceeded very efficiently in bulk at a reaction temperature of about T=50° C. to high conversion and afford polymers with excellent optical transparency. Molar masses of the resulting polymers range from about 2000 to about 20,000 g/mol. However, depending on the reaction conditions, molar masses can be readily increased up to about 1,000,000 g/mol. These new polymers, particularly those made from diallyl terephthalates are excellent commodity engineering plastics comparable to or superior to polyethylene terephthalate (PET) and polycarbonates, but with the benefits of the S—S units which can increase refractive index while using inexpensive reagents.

Synthesis of poly(S₂-DAI-Cl₂) with sulfenyl chloride inverse vulcanization

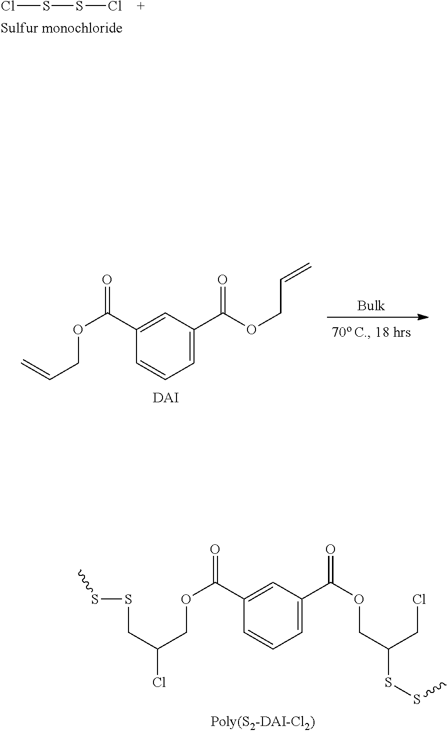

To a 10 mL vial equipped with a magnetic stir bar was added sulfur monochloride (S₂Cl₂, 1.688 g, 1 mL, 0.0125 mole) and diallyl isophthalate (3.078 g, 2.72 mL, 0.0125 mole) at T=70° C. in a thermostatted oil bath. The reaction mixture was stirred at 500 rpm for 18 hours until vitrification. After vitrification of poly(S₂-DAI-Cl₂), the reaction mixture was cooled to room temperature. A yellowish glassy polymer was dissolved in 15 mL of tetrahydrofuran, and precipitated in 30 mL of methanol, which induced dissolution of unreacted sulfur monochloride and diallyl isophthalate for purification. This purification process was conducted 3 times. The collected products were then dried at 60° C. under vacuum affording a white solid. Yield=3.56, g, Mn=20,700 g/mol, PDI=1.96.

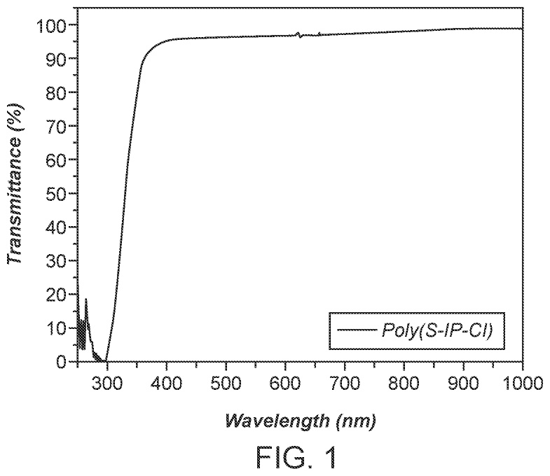

FIG. 1 shows the optical transmission spectrum of the poly(S₂-DAI-Cl₂) (also known as poly(S-IP-Cl)) polymer film (0.1 mm on glass). This polymer film exhibited greater than 80% T in the visible spectrum and a refractive index of 1.60. The same film when on glass showed high transparency and low coloration.

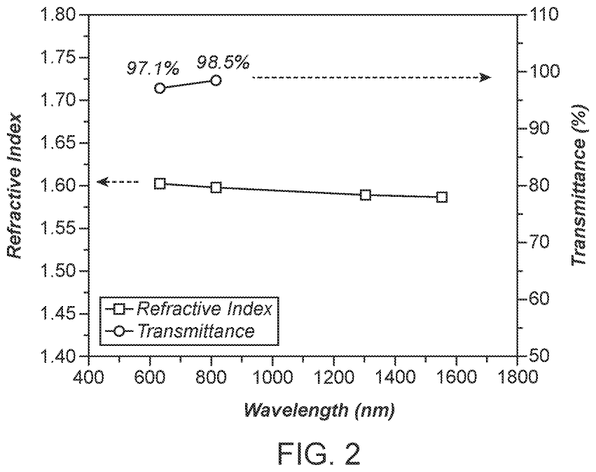

FIG. 2 shows the refractive index and transmittance (%) of the poly(S₂-DAI-Cl₂) (also known as poly(S-IP-Cl)) polymer film that was coated on a Si wafer. The below table summarizes that refractive index of the polymer film at specific wavelengths. At 633 nm wavelength, the refractive index was 1.6.

| | Refractive Index |
|---|---|
| Wavelength | (Transmittance %) |
| 633 nm | 1.6023 (97.1%) |
| 816 nm | 1.5984 (98.5%) |
| 1305 nm | 1.5894 |
| 1550 nm | 1.5873 |

### Polymer Applications and Fields of Use

Methods and processes of the invention provides new organochalcogen polymers that can be used in conventional applications as well as a wide new class of engineering plastics, adhesives, elastomers and optical polymers. Exemplary fields of use of organochalcogen polymers produced using methods or processes of the invention include, but are not limited to:

### Consumer Plastic Optics:

optical polymers and plastic optics for consumer spectacle eyeware. For this application, optical polymers should have the following properties: (a) refractive index=1.55-1.75 or 1.60-1.70, Abbe number >25, 90% T or greater in the visible spectrum (b) no color, or limited pigmentation (c) Tg, Tm>100° C. and tensile strength >20 MPa or >40 MPa.

### Proton-Free, Mid-Infrared Plastic Optics:

Use of S₂Cl₂ with alkynes and substituted halo-alkyne monomers using methods of the invention provide polymers having no C—H bonds. Accordingly, methods of the invention for the first time offers a route to engineering plastics that are proton free, without the need for fluorination. Wholly fluorinated polymers are proton free, but are expensive, superhydrophobic and not suitable for most MWIR plastic optic applications. Methods of the invention provide a route to proton-free thermoplastic, or thermoset engineering plastics that have high transparency (% T) in the mid-IR spectrum from 3-5 microns. These particular organochalcogen polymers are suitable for packaging and structural support materials for Mid-IR imaging systems.

### Synthesis of poly(S₂-triallyl isophthalate-Cl₂) with chalcogenide halide inverse vulcanization

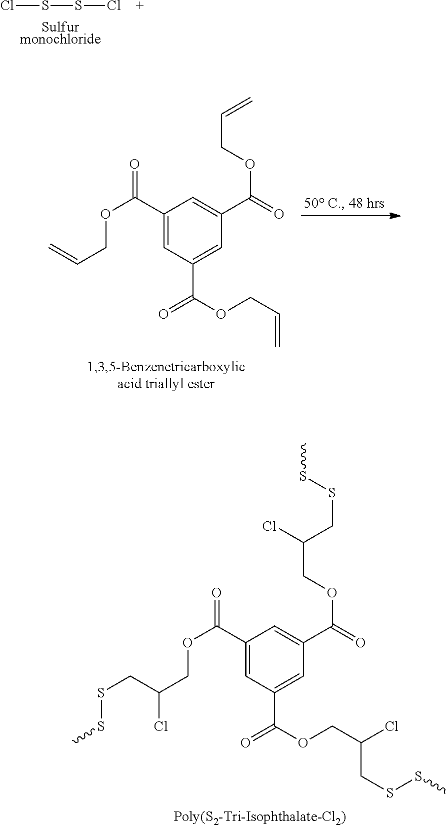

To a 10 mL vial equipped with a magnetic stir bar was added sulfur monochloride (S₂Cl₂, 0.2026 g, 0.12 mL, 0.0015 mole) at T=50° C. in a thermostated oil bath. 1,3,5-benzenetricarboxylic acid triallyl ester powder (0.5162 g, 0.00156 mole) was dissolved in 5 mL of THF and injected into the vial. The reaction mixture was stirred at 500 rpm for 48 hours. The reaction mixture was cooled to room temperature. A yellowish polymer solution was precipitated in 10 mL of methanol. The precipitated polymer was then re-dissolved in 5 mL of THF and precipitated in 10 mL of methanol. This purification process was conducted 3 times, which induced the dissolution of unreacted reagents and oligomers for the purification. The collected products were then dried at 60° C. under vacuum affording a yellowish solid. (yield=0.5032 g, Mn=2,700 g/mol, PDI=1.31).

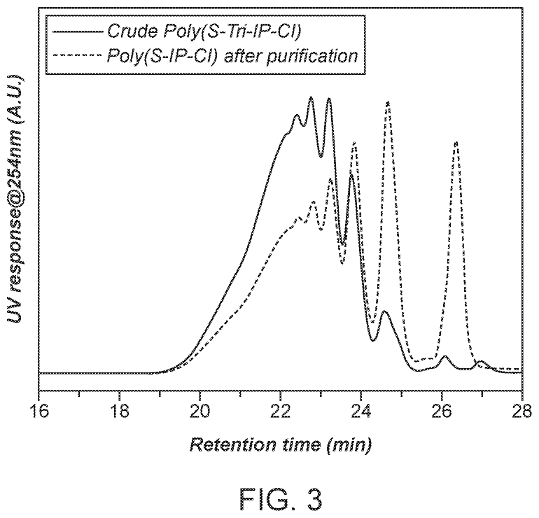

FIG. 3 shows the SEC chromatograms of the poly(disulfide-tri-isophthalate-dichloride) polymers before and after purification. The below table summarizes the properties of the poly(disulfide-tri-isophthalate-dichloride) polymers before and after purification.

| | Mₙ | M_{w} | Mₚ | PDI |
|---|---|---|---|---|
| Bulk poly(S₂-tri- | 1,235 | 2,610 | 1,033 | 2.11 |
| IP-Cl₂) | | | | |
| Purified poly(S₂- | 2,754 | 3,617 | 2,711 | 1.31 |
| tri-IP-Cl₂) | | | | |

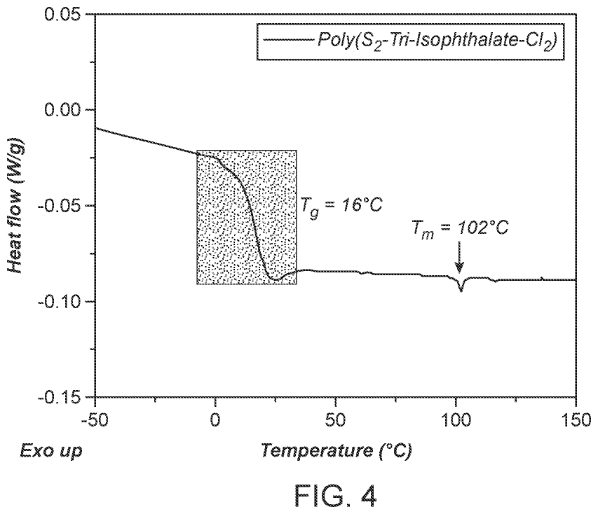

FIG. 4 shows the DSC curve of the poly(disulfide-tri-isophthalate-dichloride) polymer from −50° ° C. to 150° ° C. with a heating rate of 10° C./min. The below table summarizes the properties of the poly(disulfide-tri-isophthalate-dichloride) polymer. Tₘ was observed at 102° C., which was observed at the same temp with poly(S₂-Di-Isophthalate-Cl₂).

| | Poly(S₂-Tri-IP-Cl₂) |
|---|---|
| T_{g} (° C.) | 16 |
| Tₘ (° C.) | 102 |
| Δ Hₘ (J/g) | 0.10146 |

Reaction of S₂Cl₂ with 1,3-diethynylbenzene: To a 2 mL scintillation vial equipped with a magnetic stir bar was added 1,3-diethynylbenzene (0.49 mL, 3.85 mmol) and S₂Cl₂ (0.52 mL, 3.85 mmol). The reaction was allowed to stir for 18 hours at room temperature at which point the reaction was heated to 50° C. for 5 hours. The dark red solid was removed from the vial by scoring it with a diamond knife and breaking the vial (yield, 1.00 g).

Reaction of S₂Cl₂ with 1,3,5-triethynylbenzene: To a 2 mL scintillation vial equipped with a magnetic stir bar was added 1,3,5-triethynylbenzene (55.5 mg, 0.29 mmol) and S₂Cl₂ (0.02 mL, 0.29 mmol). Toluene was then added dropwise until the solution was soluble (˜0.1 mL). The contents of the vial were stirred at room temperature for 18 hours. The reaction was then placed under vacuum to remove the toluene. The vial was then placed in a vacuum oven at 50° C. to remove any remaining toluene. The vial was removed from the vacuum oven resulting in a brittle, yellow solid.

### Synthesis of high molecular weight poly(S₂-diallyl isophthalate-Cl₂) (poly(S₂-DAI-Cl₂))

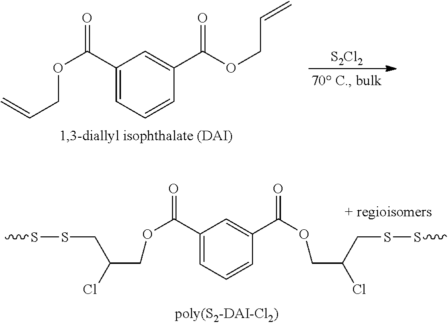

To a 20 ml scintillation vial equipped with a magnetic stir bar was added sulfur monochloride (S₂Cl₂, 0.506 g, 0.3 mL, 0.00375 mole) and diallyl isophthalate (DAI, 0.924 g, 0.82 ml, 0.00375 mole). The vial was placed in a thermostated oil bath preset at 60° C. and stirred at 500 rpm until the mixture vitrified. After vitrification, the polymer mixture was cooled to room temperature affording a yellowish glassy polymer. The glassy polymer mixture was dissolved in 10 mL anhydrous THF and precipitated in 30 mL of methanol to induce the removal of unreacted S₂Cl₂ and DAI. The purification process was conducted 3 times, and the collected solid polymer was then dried at 60° C. under vacuum affording a white powder. (Yield=1.18 g, Mₙ=38,000 g/mol, PDI=2.14, CHS Elemental Analysis: C=43.79%, H=4.26%, S=17.14%).

The poly(S₂-DAI-C12) obtained from the above procedure had a Mn=82,000 and Mw/Mn=1.7, which where confirmed by THF-SEC. 1H NMR spectroscopy of the poly(S₂-DAI-Cl₂) and model reactions of S₂Cl₂ with allyl benzoate indicates a 60:40 molar ratio of (—SS—CH2-CHR—Cl) vs (—SS—CHR-CH2-Cl) regiosomer units were formed from this polymerization, along with stereoisomers formed by —CHR—S— and —CHR—Cl fragments. The chemical stability of DAI in S₂Cl₂ solutions also indicates that allylic monomers can be safely mixed with S₂Cl₂ for bulk polymerizations and then heated to elevated temperatures, which is amenable to meltprocessing for molding of lenses and windows. TGA of the isolated poly(S₂-DAI-Cl₂) powder indicated thermal stability until around T_{decomp}˜300° C., which confirmed that the β-halothioether and disulfide units of these polymers exhibited acceptable thermal stability that was comparable to other known optical polymers, such as, PMMA and poly(vinyl chloride (PVC) that decompose at similar temperatures. DSC of the isolated poly(S₂-DAI-Cl₂) detected a single Tg=35° C. indicating that an amorphous material was prepared.

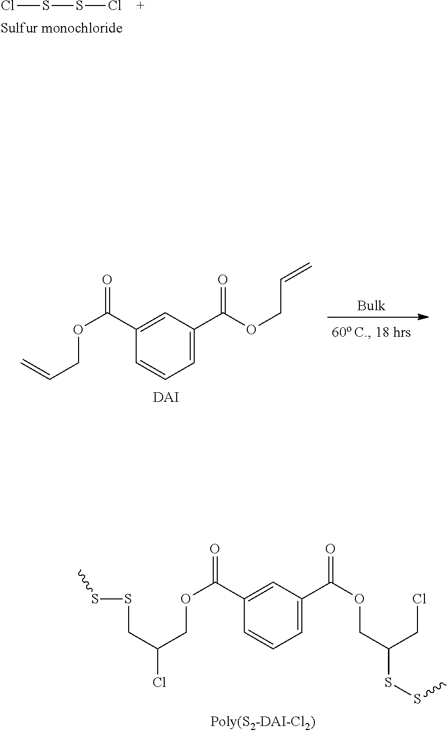

To a 8 ml scintillation vial equipped with a magnetic stir bar was added sulfur monochloride (S₂Cl₂, 0.506 g, 0.3 mL, 3.75 mmol, 1 equiv.) and diallyl isophthalate (DAI, 0.924 g, 0.82 ml, 3.75 mmol, 1 equiv.). The vial was placed in an oil bath preset at 60° C. and stirred at 500 rpm under Ar until the mixture vitrified. After vitrification, the polymer mixture was cooled to room temperature affording a yellowish glassy polymer. The glassy polymer mixture was dissolved in 10 mL anhydrous THF and precipitated in 30 mL of methanol to induce the removal of unreacted S₂Cl₂ and DAI. The purification process was conducted 3 times, and the collected product was then dried at 60° C. under vacuum affording a white powder. (Yield=1.18 g, Mₙ=55,998 g/mol, Mw=183,399 g/mol, PDI=3.28).

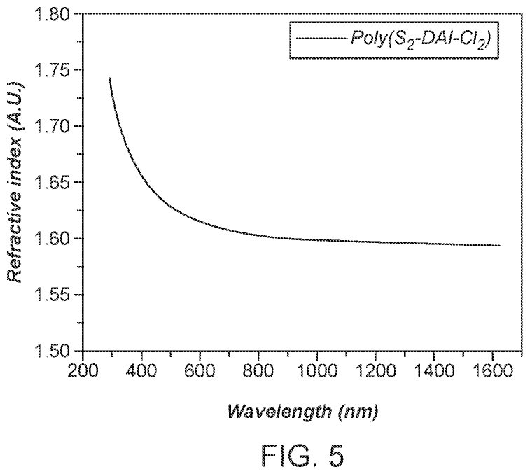

FIG. 5 shows the ellipsometric characterization of the refractive index vs wavelength for the above described poly(S₂-DAI-Cl₂) polymer. The below table shows the refractive index at 486 nm, 589 nm and 656 nm and the Abbe number calculation.

| | Poly(S₂-DAI-Cl₂) |
|---|---|
| 486.1 nm | 1.631 |
| 589.3 nm | 1.617 |
| 656.3 nm | 1.611 |
| Abbe number | 30.85 |

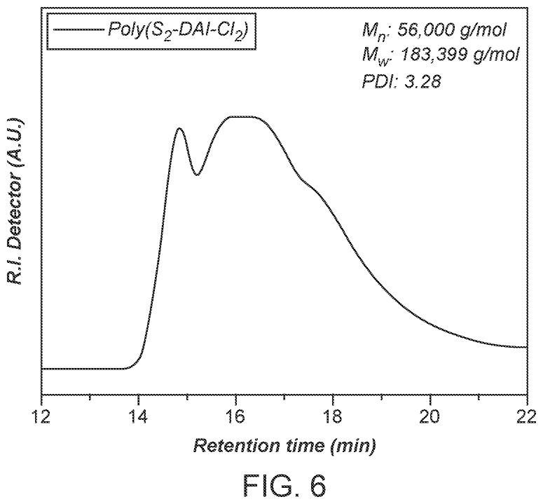

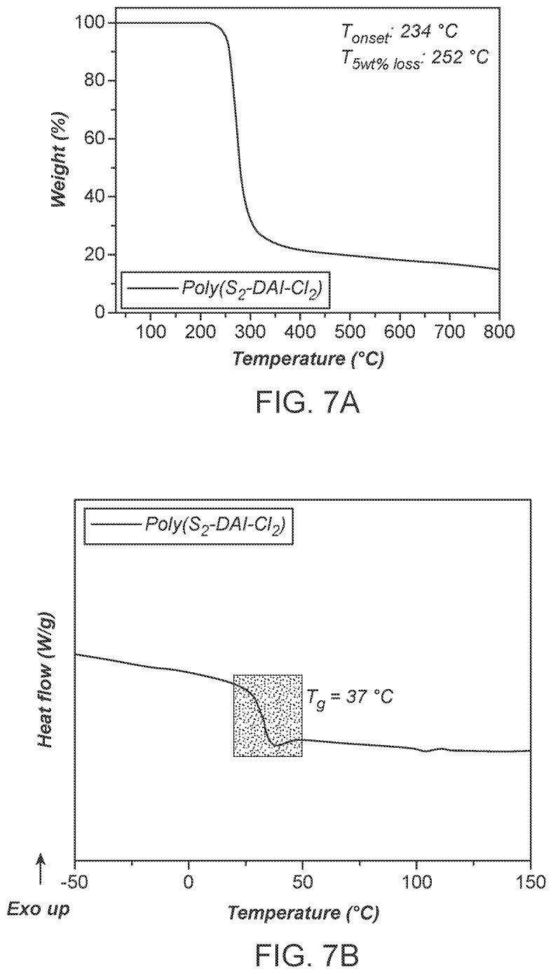

FIG. 6 shows SEC chromatogram the of poly(S₂-DAI-Cl₂) polymer in THF mobile phase. FIGS. 7A and 7B show the TGA and DSC thermograms of poly(S₂-DAI-Cl₂) polymer.

The poly(S₂-DAI-Cl₂) polymers prepared herein also exhibited promising polymer processing characteristics and optical properties in the visible spectrum. This material was readily hot-pressed into free standing films (700 μm thickness) and spin coated onto glass from toluene (100 μm thickness), both of which appeared to afford colorless (or low coloration), transparent polymers. Optical UV-Vis absorbance spectra of 100 μm thick films on glass exhibited very high transmittance across the visible spectrum (>92% T using glass as a reference). Finally, prism coupling measurements were used to determine the refractive index at the sodium D (589 nm), hydrogen F (486.1 nm), and hydrogen C (656.3 nm) lines ranging from n=1.60-1.62, and a high Abbe number (V_{D}=35). These collective findings demonstrate the polymers made via S₂Cl₂ polymerizations possess an attractive set of optical properties (n>1.6, Abbe number >30, low coloration, thiol free synthesis) for consumer plastic optics.

### Synthesis of high molecular weight poly(S₂-diallyl tetrabromo-bisphenol A-Cl₂) (poly(S₂-DABr₄BPA-Cl₂))

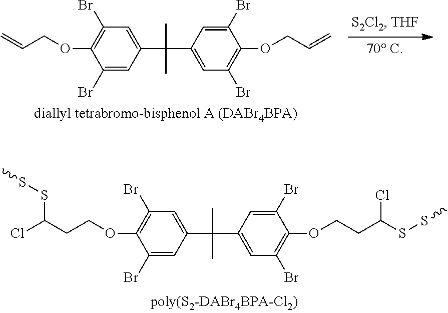

To a 20 mL vial equipped with a magnetic stir bar was added diallyl tetrabromo bisphenol A (DABr₄BPA, 1.560 g, 0.0025 mole) in 1 mL of anhydrous toluene, sulfur monochloride (S₂Cl₂, 0.338 g, 0.2 mL, 0.0025 mole) was then injected into the solution at the room temperature. The vial was placed in a thermostated oil bath preset at 60° C. and stirred at 500 rpm until the mixture vitrified. After vitrification, the polymer mixture was cooled to room temperature affording a yellowish glassy polymer. The glassy polymer mixture was dissolved in 10 mL anhydrous THF and precipitated in 30 mL of hexane to induce the removal of unreacted S₂C12 and DABr₄BPA. The purification process was conducted 3 times, and the collected products were dried at 60° C. under vacuum affording a white powder. (Yield=1.624 g, Mn=102,000 g/mol, PDI=2.2, CHS Elemental Analysis: C=34.77%, H=3.12%, S=10.12%).

The poly(S₂-DABr₄BPA-Cl₂) obtained from the above procedure had a Mn=102,000 and Mw/Mn=2.2. TGA of the isolated poly(S₂-DABr₄BPA-Cl₂) powder indicated thermal stability until around T_{decomp}<238° C. The Tg of the isolated poly(S₂-DAI-Cl₂) was detected Tg˜76° C.

The poly(S₂-DABr₄BPA-Cl₂) polymers prepared herein also exhibited promising polymer processing characteristics and optical properties in the visible spectrum. This material was spin coated onto glass from toluene (100 μm thickness), which appeared to afford low coloration, transparent polymers. Optical UV-Vis absorbance spectra of 100 μm thick films on glass exhibited very high transmittance across the visible spectrum (>95% T at 633 nm using glass as a reference). Finally, prism coupling measurements were used to determine the refractive index at the sodium D (589 nm), hydrogen F (486.1 nm), and hydrogen C (656.3 nm) lines ranging from n=1.64-1.66, and a high Abbe number (V_{D}=30).

### Synthesis of high molecular weight poly(S₂-triallyl isocyanurate-Cl₂) (poly(S₂-TIC-Cl₂))

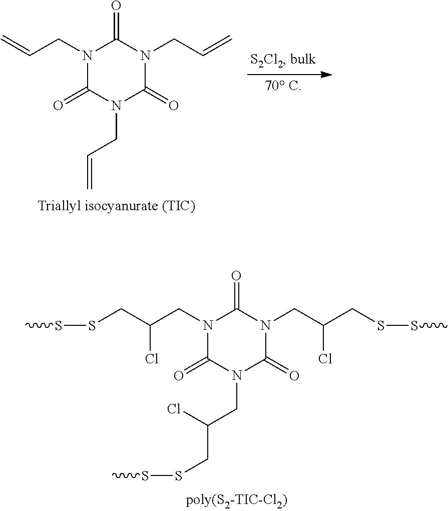

To a 20 mL vial equipped with a magnetic stir bar was added sulfur monochloride (S₂Cl₂, 1.688 g, 1 mL, 0.0125 mole) and triallyl isocyanurate (2.8326 g, 2.444 mL, 0.0113636 mole) to T=50° C. in a thermostated oil bath. The reaction mixture was stirred by 500 rpm until the high viscosity. The magnetic stir bar was removed from the reaction vial for the fabrication of the window. The reaction temperature was then increased to 70° C. for 24 hours. Then, the reaction mixture in vial was placed in 120° C. convection oven. The yellowish window was then collected from the vial.

TGA of the isolated poly(S₂-TIC-Cl₂) powder indicated thermal stability until around T_{decomp}<256° C. The Tg of the isolated poly(S₂-TIC-Cl₂) was detected Tg˜ 93° C.

The poly(S₂-TIC-Cl₂) polymers prepared herein also exhibited promising polymer processing characteristics and optical properties in the visible spectrum. The polymer exhibited a RI ranging from n=1.58-1.29 and a high Abbe number (V_{D}=34).

To raise the refractive index of these thermoset windows without the need for halogenated monomers (e.g., from n˜1.6 to n˜1.65-1.70), sulfur monochloride and TIC monomers were premixed with elemental sulfur derived copolymers, in this case poly(S-r-Sty) (50-wt % sulfur), thereby allowing for a higher sulfur content to be introduced into the S—Cl inverse vulcanization process. The addition and blending of poly(S₂-TIC-Cl₂) with poly(S-r-Sty) afforded transparent red thermoset windows that indicate efficient mixing and curing of these components for the first time.

### Synthesis of high molecular weight poly(S₂-triallyl isocyanurate-diallyl tetrabromo-bisphenol A-Cl₂) (poly(S₂-TIC-DABr₄BPA-Cl₂))

To a 20 mL vial equipped with a magnetic stir bar was added triallyl isocyanurate (TIC, 1.6226 g, 1.4 mL, 0.0065 mole) and diallyl tetrabromo-bisphenol A (DABr₄BPA, 0.8113 g, 0.0013 mole) to T=70° C. in a thermostated oil bath. The reaction mixture was stirred by 500 rpm until homogeneous. Sulfur monochloride (S₂Cl₂, 1.2655 g, 0.749 mL, 0.0093 mole) was then injected into the reactor. The magnetic stir bar was removed from the reaction vial for the fabrication of the window. The reaction temperature was then increased to 70° C. for 24 hours. Then, the reaction mixture in vial was placed in 120° C. convection oven. The yellowish window was then collected from the vial.

TGA of the isolated poly(S₂-TIC-DABr₄BPA-Cl₂) powder indicated thermal stability until around T_{decomp}>260° C. The Tg of the isolated poly(S₂-TIC-DABr₄BPA-Cl₂) was detected Tg˜89-90° C.

The poly(S₂-TIC-DTBBPA-Cl₂) polymers prepared exhibited promising polymer processing characteristics and optical properties in the visible spectrum. The polymer exhibited a RI of ranging from 1.61-1.62 and a high Abbe number (V_{D}=30). Also a high transmittance around 85% between 800-900 nm was observed with thick 5 mm windows that were prepared with the poly(S₂-TIC-DTBBPA-Cl₂) polymers, which were also easy to process and polish. Also ultra-thick, highly transparent thermoset windows (thickness: 7 mm, 17 mm, 34 mm and 50 mm) could also be prepared. The diameters of these windows in these examples were only limited to the reactors used for these samples which were 25 mm in diameter. These windows were highly transparent above 500 nm into the SWIR around 1500 nm.

### Other Exemplary Reactions:

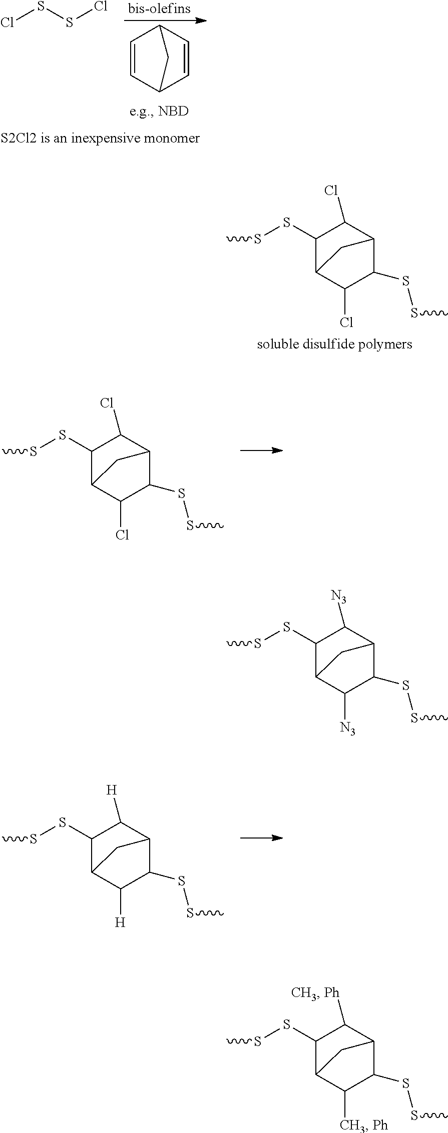

In some embodiments, Cl groups can be replaced with other reactive, or stable groups including, but not limited to, azide (e.g., using NaN₃) or other conventional side chain groups (e.g., alkyl, Ph-CH₃— group, etc. to modify Tg and/or solubility). Still in other embodiments, chloride can be replaced with hydrogen (e.g., by selective hydrogenation without cleaving S—S bond).

As discussed above, methods of the invention can also utilize other chalcogen halide such as selenium monochloride to produce a product that is similar to using sulfur monochloride:

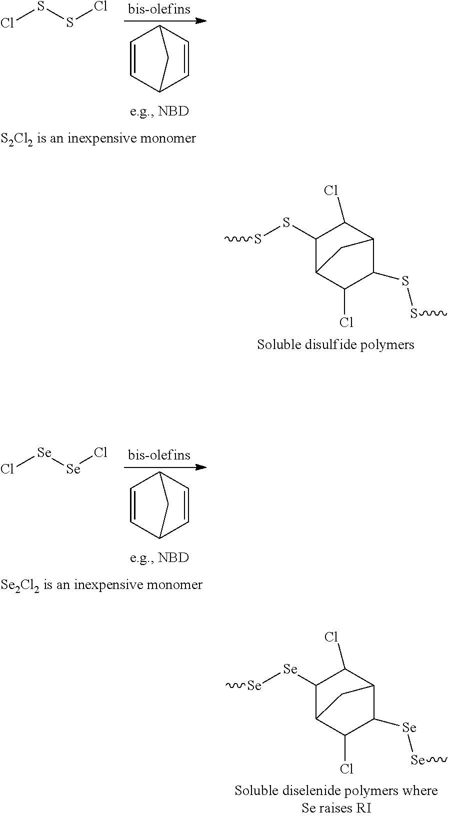

Other useful olefins include organic compounds shown below:

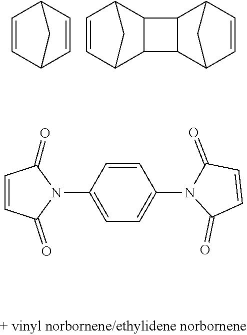

Using a selenium tetrahalide, such as selenium tetrachloride, produces crosslinked polymers as exemplified below.

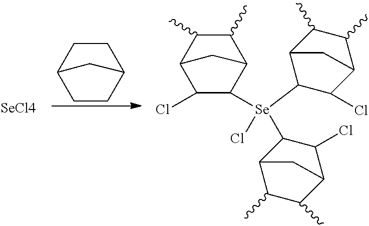

One can also increase the amount of sulfur in organochalcogen polymers of the present invention, for example, by utilizing the following process:

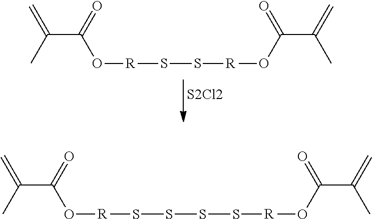

Such a process can be used to increase sulfur rank and sulfur content as some olefins, such as methacrylates, do not readily react with S—Cl. Similarly, one can also increase Se—S rank, allowing production of organochalcogen polymers having increased refractive index.

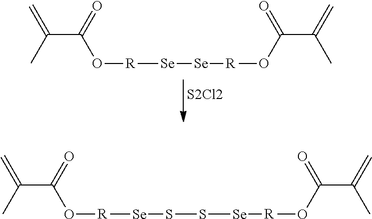

### Embodiments

Embodiment 1. A process for producing an organochalcogenide polymer, said process comprising admixing a monomeric mixture comprising: (i) a chalcogenide halide and (ii) an organic compound comprising an unsaturated carbon-carbon bond, under reaction conditions sufficient to produce said organochalcogenide polymer, wherein said chalcogenide halide is selected from the group consisting of sulfur monohalide, sulfur dihalide, selenium monohalide, selenium dihalide, selenium tetrahalide, and a combination thereof.

Embodiment 2. The process of Embodiment 1, wherein said chalcogenide halide is selected from the group consisting of sulfur monochloride, sulfur monobromide, selenium monochloride, selenium monobromide, selenium dichloride, selenium dibromide, selenium tetrachloride, selenium tetrabromide and a combination thereof.

Embodiment 3. The process of Embodiment 1 or Embodiment 2, wherein said chalcogenide halide is selected from the group consisting of sulfur monochloride, sulfur dichloride, selenium monochloride, selenium dichloride, selenium tetrachloride, and a combination thereof.

Embodiment 4. The process of any one of Embodiments 1-3, wherein said monomeric mixture is admixed in the presence of an organic solvent.

Embodiment 5. The process of Embodiment 4, wherein said organic solvent comprises a polar organic solvent, a non-polar aprotic organic solvent, or a combination thereof.

Embodiment 6. The process of Embodiment 5, wherein said organic solvent comprises tetrahydrofuran, toluene, benzene, xylene, chlorobenzene, dichlorobenzene, diethyl glycol, N,Ndimethylformamide, carbon disulfide, halogenated solvents such as dichloromethane, chloroform or a combination thereof.

Embodiment 7. The process of any one of Embodiments 1-6, wherein said unsaturated carbon-carbon bond comprises a carbon-carbon double bond, a carbon-carbon triple bond, or a combination thereof.

Embodiment 8. The process of any one of Embodiments 1-7, wherein said organic compound comprises vinyl, allyl, styrenic, a-methylstyrenic, (meth)acrylate, norbornenes, cyclic olefins, vinylogous sulfides and other substituted alkenes, substituted olefins, maleimides, maleic anhydrides.

Embodiment 9. The process of any one of Embodiments 1-8, wherein said organochalcogenide polymer is produced at a reaction temperature of about 200° C. or less.

Embodiment 10. The process of any one of Embodiments 1-9, further comprising purifying said organochalcogenide polymer.

Embodiment 11. The process of Embodiment 10, wherein said step of purifying said organochalcogenide polymer comprises the steps of: (a) dissolving said organochalcogenide polymer in an organic solvent to produce a homogeneous solution; (b) precipitating said organochalcogenide polymer to produce at least a partially purified organochalcogenide polymer; and (c) optionally repeating steps (a) and (b).

Embodiment 12. The process of Embodiment 11, wherein said organochalcogenide polymer has a purity of at least 90%.

Embodiment 13. The process of any one of Embodiments 1-12, wherein a yield of said organochalcogenide polymer is about 50% or higher relative to the amount of said organic compound used.

Embodiment 14. The process of any one of Embodiments 1-13, wherein an amount of said chalcogenide halide used is about 80 mole % or less relative to an amount of said organic compound.

Embodiment 15. The process of any one of Embodiments 1-14, wherein said organic compound comprises at least two unsaturated carbon-carbon bonds.

Embodiment 16. The process of any one of Embodiments 1-15, wherein said organic compound comprises at least three unsaturated carbon-carbon bonds.

Embodiment 17. An organochalcogenide polymer produced from a process comprising admixing a monomeric mixture comprising: (i) a chalcogenide halide and (ii) an organic compound comprising an unsaturated carbon-carbon bond under reaction conditions sufficient to produce said organochalcogenide polymer, wherein said chalcogenide halide is selected from the group consisting of sulfur monohalide, sulfur dihalide, selenium monohalide, selenium dihalide, selenium tetrahalide, and a combination thereof.

Embodiment 18. The organochalcogenide polymer of Embodiment 17, wherein a refractive index of said organochalcogenide polymer ranges from about 1.5 to about 1.75 in a visible spectrum.

Embodiment 19. The organochalcogenide polymer of Embodiments 17 or 18, wherein an Abbe number of said organochalcogenide polymer is about 20 or higher.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the claims appended hereto.

### REFERENCES

1. Abu-yousef, I. A.; Harpp, D. N., New Sulfenyl Chloride Chemistry: Synthesis, Reactions and Mechanisms Toward Carbon-Carbon Double Bonds. Sulfur Reports 2003, 24 (3), 255-282.
2. Abu-Yousef, I. A., The organic chemistry of diatomic sulfur. Journal of Sulfur Chemistry 2006, 27 (1), 87-119.
3. Fahey, R. C., The Stereochemistry of Electrophilic Additions to Olefins and Acetylenes. In Topics in Stereochemistry, 1968; pp 237-342.
4. Gundermann, K. D., Neighboring Group and Substituent Effects in Organosulfur Compounds. Angewandte Chemie International Edition in English 1963, 2 (11), 674-683.
5. Hoyle, C. E.; Bowman, C. N., Thiol-Ene Click Chemistry. Angewandte Chemie International Edition 2010, 49 (9), 1540-1573.
6. Lowe, A. B., Thiol-ene “click” reactions and recent applications in polymer and materials synthesis. Polymer Chemistry 2010, 1 (1), 17-36.
7. Lowe, A. B., Thiol-ene “click” reactions and recent applications in polymer and materials synthesis: a first update. Polymer Chemistry 2014, 5 (17), 4820-4870.
8. Rakitin, O. A.; Konstantinova, L. S., Chapter 4 Sulfur Monochloride in the Synthesis of Heterocyclic Compounds. 2008; pp 175-229.
9. Glazer, J., Dilatometric Measurement of the Rate of Vulcanizaton of Crêpe-Rubber by Sulphur Monochloride. Nature 1951, 167 (4245), 404-405.
10. Akiba, M.; Hashim, A. S., Vulcanization and crosslinking in elastomers. Prog. Polym. Sci. 1997, 22, 475-521.
11. Lautenschlaeger, F., The reaction of bicyclo[2.2.1]-2,5-heptadiene with sulfur dichloride. J. Org. Chem. 1966, 31 (6), 1679-82.
12. Lautenschlaeger, F., Reaction of sulfur dichloride with cyclic polyolefins. J. Org. Chem. 1968, 33 (7), 2627-33.
13. Pielichowski, J., A New Reaction of N-Vinylcarbazole with Disulfur Dichloride. Angewandte Chemie International Edition in English 1969, 8 (11), 877-878.
14. Díaz, D. D.; Converso, A.; Sharpless, K. B.; Finn, M. G., 2,6-Dichloro-9-thiabicyclo[3.3.1]nonane: Multigram Display of Azide and Cyanide Components on a Versatile Scaffold. Molecules 2006, 11 (4), 212-218.
15. Meyers, R. A.; Wilson, E. R., Copolymerization Of Sulfur Monochloride With Cyclopentadiene. Polymer Letters 1968, 6, 587-591.
16. Meyers, R. A.; Wilson, E. R., A novel polymerization reaction. Polymer Letters 1968, 6, 531-534.
17. Meyers, R. A.; Hom, J., Addition Copolymerization of Sulfur Dichloride and Sulfur Monochloride with 1,3-Butadiene. Journal of Macromolecular Science: Part A-Chemistry 1969, 3 (2), 169-176.
18. Yoo, J.; D'Mello, S. R.; Graf, T.; Salem, A. K.; Bowden, N. B., Synthesis of the First Poly(diaminosulfide)s and an Investigation of Their Applications as Drug Delivery Vehicles. Macromolecules 2012, 45 (2), 688-697.
19. Geary, S. M.; Hu, Q.; Joshi, V. B.; Bowden, N. B.; Salem, A. K., Diaminosulfide based polymer microparticles as cancer vaccine delivery systems. Journal of Controlled Release 2015, 220, 682-690.
20. Chung, W. J.; Griebel, J. J.; Kim, E. T.; Yoon, H.; Simmonds, A. G.; Ji, H. J.; Dirlam, P. T.; Glass, R. S.; Wie, J. J.; Nguyen, N. A.; Guralnick, B. W.; Park, J.; Somogyi, Á.; Theato, P.; Mackay, M. E.; Sung, Y.-E.; Char, K.; Pyun, J., The use of elemental sulfur as an alternative feedstock for polymeric materials. Nature Chemistry 2013, 5 (6), 518-524.
21. Griebel, J. J.; Namnabat, S.; Kim, E. T.; Himmelhuber, R.; Moronta, D. H.; Chung, W. J.; Simmonds, A. G.; Kim, K.-J.; van der Laan, J.; Nguyen, N. A.; Dereniak, E. L.; Mackay, M. E.; Char, K.; Glass, R. S.; Norwood, R. A.; Pyun, J., New Infrared Transmitting Material via Inverse Vulcanization of Elemental Sulfur to Prepare High Refractive Index Polymers. Advanced Materials 2014, 26 (19), 3014-3018.
22. Lim, J.; Pyun, J.; Char, K., Recent Approaches for the Direct Use of Elemental Sulfur in the Synthesis and Processing of Advanced Materials. Angewandte Chemie International Edition 2015, 54 (11), 3249-3258.
23. Griebel, J. J.; Glass, R. S.; Char, K.; Pyun, J., Polymerizations with elemental sulfur: A novel route to high sulfur content polymers for sustainability, energy and defense. Progress in Polymer Science 2016, 58, 90-125.
24. Zhang, Y.; Glass, R. S.; Char, K.; Pyun, J., Recent advances in the polymerization of elemental sulphur, inverse vulcanization and methods to obtain functional Chalcogenide Hybrid Inorganic/Organic Polymers (CHIPS). Polymer Chemistry 2019, 10 (30), 4078-4105.
25. Kleine, T. S.; Glass, R. S.; Lichtenberger, D. L.; Mackay, M. E.; Char, K.; Norwood, R. A.; Pyun, J., 100th Anniversary of Macromolecular Science Viewpoint: High Refractive Index Polymers from Elemental Sulfur for Infrared Thermal Imaging and Optics. ACS Macro Letters 2020, 9 (2), 245-259.
26. Griebel, J. J.; Nguyen, N. A.; Namnabat, S.; Anderson, L. E.; Glass, R. S.; Norwood, R. A.; MacKay, M. E.; Char, K.; Pyun, J., Dynamic Covalent Polymers via Inverse Vulcanization of Elemental Sulfur for Healable Infrared Optical Materials. ACS Macro Lett. 2015, 4 (9), 862-866.
27. Kleine, T. S.; Nguyen, N. A.; Anderson, L. E.; Namnabat, S.; LaVilla, E. A.; Showghi, S. A.; Dirlam, P. T.; Arrington, C. B.; Manchester, M. S.; Schwiegerling, J.; Glass, R. S.; Char, K.; Norwood, R. A.; Mackay, M. E.; Pyun, J., High Refractive Index Copolymers with Improved Thermomechanical Properties via the Inverse Vulcanization of Sulfur and 1,3,5-Triisopropenylbenzene. ACS Macro Lett. 2016, 5 (10), 1152-1156.
28. Anderson, L. E.; Kleine, T. S.; Zhang, Y.; Phan, D. D.; Namnabat, S.; La Villa, E. A.; Konopka, K. M.; Ruiz Diaz, L.; Manchester, M. S.; Schwiegerling, J.; Glass, R. S.; Mackay, M. E.; Char, K.; Norwood, R. A.; Pyun, J., Chalcogenide Hybrid Inorganic/Organic Polymers: Ultrahigh Refractive Index Polymers for Infrared Imaging. ACS Macro Lett. 2017, 6 (5), 500-504.
29. Babaeian, M.; Diaz, L. R.; Namnabat, S.; Kleine, T. S.; Azarm, A.; Pyun, J.; Peyghambarian, N.; Norwood, R. A., Nonlinear optical properties of chalcogenide hybrid inorganic/organic polymers (CHIPs) using the Z-scan technique. Optical Materials Express 2018, 8 (9), 2510-2519.
30. Kleine, T. S.; Diaz, L. R.; Konopka, K. M.; Anderson, L. E.; Pavlopolous, N. G.; Lyons, N. P.; Kim, E. T.; Kim, Y.; Glass, R. S.; Char, K.; Norwood, R. A.; Pyun, J., One Dimensional Photonic Crystals Using Ultrahigh Refractive Index Chalcogenide Hybrid Inorganic/Organic Polymers. ACS Macro Lett. 2018, 7 (7), 875-880.
31. Kleine, T. S.; Lee, T.; Carothers, K. J.; Hamilton, M. O.; Anderson, L. E.; Ruiz Diaz, L.; Lyons, N. P.; Coasey, K. R.; Parker, W. O., Jr.; Borghi, L.; MacKay, M. E.; Char, K.; Glass, R. S.; Lichtenberger, D. L.; Norwood, R. A.; Pyun, J., Infrared Fingerprint Engineering: A Molecular-Design Approach to Long-Wave Infrared Transparency with Polymeric Materials. Angewandte Chemie, International Edition 2019, 58 (49), 17656-17660.
32. Pavlopoulos, N. G.; Kang, K. S.; Holmen, L. N.; Lyons, N. P.; Akhoundi, F.; Carothers, K. J.; Jenkins, S. L.; Lee, T.; Kochenderfer, T. M.; Phan, A.; Phan, D.; Mackay, M. E.; Shim, I. B.; Char, K.; Peyghambarian, N.; LaComb, L. J.; Norwood, R. A.; Pyun, J., Polymer and magnetic nanoparticle composites with tunable magneto-optical activity: role of nanoparticle dispersion for high verdet constant materials. Journal of Materials Chemistry C 2020, 8 (16), 5417-5425.
33. Carothers, K. J.; Lyons, N. P.; Pavlopoulos, N. G.; Kang, K.-S.; Kochenderfer, T. M.; Phan, A.; Holmen, L. N.; Jenkins, S. L.; Shim, I.-B.; Norwood, R. A.; Pyun, J., Polymer-Coated Magnetic Nanoparticles as Ultrahigh Verdet Constant Materials: Correlation of Nanoparticle Size with Magnetic and Magneto-Optical Properties. Chemistry of Materials 2021, 33 (13), 5010-5020.
34. Dislich, H., Plastics as optical materials. Angewandte Chemie, International Edition 1979, 18, 49-59.
35. Rubin, M. L., Spectacles: Past, Present and Future. Surv. Ophthalmol. 1986, 30, 321.
36. A., C., High Refractive Index Plastic Optical Materials. VDM Verlag: 2009.
37. Liu, J.-g.; Ueda, M., High refractive index polymers: fundamental research and practical applications. Journal of Materials Chemistry 2009, 19 (47), 8907-8919.
38. Morishiri, H.; Kobayashi, S. Episulfide compound with high refractive index. Jpn Kokai Tokkyo Koho 325274 2005.
39. Morishiri, H.; Kobayashi, S. Polythiols, transparent polymer compositions containing them, their polymers, their manufacture their heat-resistant optical materials and lenses with high refractive index. Jpn Kokai Tokkyo Koho 131724 2006.
40. Higashihara, T.; Ueda, M., Recent Progress in High Refractive Index Polymers. Macromolecules 2015, 48 (7), 1915-1929.
41. Tsukada, H.; Kawaguchi, M. Process for producing episulfide compound for optical material, episulfide-containing composition, and polymerizable composition for optical material including the same composition. U.S. patent Ser. No. 10/266,636, 2019.
42. Okubo, T.; Kohmoto, S.; Yamamoto, M., Optical Polymer Having a High Refractive Index and High Abbe Number Prepared by Radical Polymerization Using 2,5-BiS(2-Thia-3-Butenyl)-1,4-Dithiane. Journal of Macromolecular Science, Part A 1998, 35 (11), 1819-1834.
43. Okutsu, R.; Ando, S.; Ueda, M., Sulfur-Containing Poly(meth)acrylates with High Refractive Indices and High Abbe's Numbers. Chemistry of Materials 2008, 20 (12), 4017-4023.
44. Okutsu, R.; Suzuki, Y.; Ando, S.; Ueda, M., Poly(thioether sulfone) with High Refractive Index and High Abbe's Number. Macromolecules 2008, 41 (16), 6165-6168.
45. Bhagat, S. D.; Chatterjee, J.; Chen, B.; Stiegman, A. E., High Refractive Index Polymers Based on Thiol-Ene Cross-Linking Using Polarizable Inorganic/Organic Monomers. Macromolecules 2012, 45 (3), 1174-1181.
46. Su, Y.; Filho, E. B. D. S.; Peck, N.; Chen, B.; Stiegman, A. E., High Refractive Index Polymers (n>1.7), Based on Thiol-Ene Cross-Linking of Polarizable P—S and P═Se Organic/Inorganic Monomers. Macromolecules 2019, 52 (22), 9012-9022.
47. Shigenori, K.; Mamoru, T.; Munehito, F.; Seiichi, K. Production method of polyepithiol-ethyl compound. Jpn Kokai Tokkyo Koho 4205329, 2009

What is claimed is:

1. A composition comprising a polymer that is a reaction product of a mixture of a chalcogenide halide and one or more organic compounds comprising an unsaturated carbon-carbon bond under reaction conditions sufficient to produce the polymer, wherein the chalcogenide halide comprises a sulfur monohalide, a sulfur dihalide, a selenium monohalide, a selenium dihalide, a selenium tetrahalide, or a combination of any two or more thereof.

2. The composition of claim 1, wherein the chalcogenide halide is selected from the group consisting of sulfur monochloride, sulfur monobromide, selenium monochloride, selenium monobromide, selenium dichloride, selenium dibromide, selenium tetrachloride, selenium tetrabromide, and a combination of any two or more thereof.

3. The composition of claim 1, wherein the chalcogenide halide is sulfur monochloride.

4. The composition of claim 1, wherein the organic compound comprises at least two unsaturated carbon-carbon bonds.

5. The composition of claim 1, wherein the organic compound comprises a vinyl olefin, an allyl olefin, a styrenic olefin, an α-methylstyrenic olefin, a (meth)acrylate olefin, a norbornene, a cyclic olefin, a vinylogous sulfide, a substituted alkene olefin, a maleimide, a maleic anhydride, or a combination of any two or more thereof.

6. The composition of claim 1, wherein the organic compound comprises a terephthalate, an isophthalate, a bisphenol A or derivative thereof, 4,4-methylene diphenyl (MDI), a trifunctional terephthalate, a tris-phenolic core, a isocyanurate, a phosphazene, a siloxane, a isocorbide, a naturally occurring product, or a combination of any two or more thereof.

7. The composition of claim 1, wherein the organic compound comprises 1,3-diallyl isophthalate (DAI), diallyl tetrabromo-bisphenol A (DABr₄BPA), triallyl isocyanurate (TIC), or a combination of any two or more thereof.

8. The composition of claim 1, wherein the organic compound comprises a terephthalate, an isophthalate, a bisphenol A or derivative thereof, 4,4-methylene diphenyl (MDI), a trifunctional terephthalate, a tris-phenolic core, a isocyanurate, a phosphazene, a siloxane, a isocorbide, a naturally occurring product, or a combination of any two or more thereof.

9. The composition of claim 1, wherein the polymer is produced by a process comprising admixing a monomeric mixture comprising the chalcogenide halide and the one or more organic compound comprising an unsaturated carbon-carbon bond under suitable reaction conditions.

10. The composition of claim 9, wherein the process is conducted at a reaction temperature of about 200° C. or less or about 100° C. or less.

11. The composition of claim 9, wherein the monomeric mixture further comprises one or more elemental sulfur derived copolymers.

12. The composition of claim 1, wherein the polymer has a refractive index of about 1.6 or higher in a visible spectrum, or near and/or short wave infrared spectral windows.

13. The composition of claim 1, wherein the polymer has an Abbe number of about 20 or higher.

14. The composition of claim 1, wherein the polymer has a high molecular weight (e.g., >10,000 g/mol) and/or wherein the polymer has a number averaged molecular weight (Mn) of about 10,000 or greater.

15. The composition of claim 1, wherein the polymer has an optical transmittance of about 90% or greater in the visible, NIR, or SWIR spectrum.

16. The composition of claim 1, wherein the composition is a thermoplastic material that is soluble and melt processable.

17. The composition of claim 1, wherein the composition is a thermoset material with high transparency in the visible spectrum and is amorphous and glassy.

18. A process for producing the composition of claim 1, the process comprising admixing a monomeric mixture comprising a chalcogenide halide and an organic compound comprising an unsaturated carbon-carbon bond under reaction conditions sufficient to produce a polymer, wherein said chalcogenide halide comprises a sulfur monohalide, a sulfur dihalide, a selenium monohalide, a selenium dihalide, a selenium tetrahalide, or a combination of any two or more thereof.

19. The process of claim 18 further comprising purifying the polymer by dissolving the polymer in an organic solvent to produce a homogeneous solution, and precipitating said the polymer to produce at least a partially purified the polymer.

20. The process of claim 19, wherein the polymer has a purity of at least 90%.
